(19) United States
(12) Patent Application Publication
(10) Pub. No.: US 2026/0110613 A1
(43) Pub. Date: Apr. 23, 2026

(54) Micro-nano particle characterization system and characterization method based on AC photovoltaic effect

(71) Applicant: Sichuan Haina Huayu Technology Co., Ltd, Chengdu City (CN)

(72) Inventors: Haiyang ZOU, Chengdu City (CN); Yu LIU, Chengdu City (CN)

(73) Assignee: Sichuan Haina Huayu Technology Co., Ltd, Chengdu City (CN)

(21) Appl. No.: 19/428,159

(22) Filed: Dec. 20, 2025

Related U.S. Application Data
(63) Continuation of application No. PCT/CN2025/139328, filed on Dec. 2, 2025.

(30) Foreign Application Priority Data
May 13, 2025 (CN) 202510613045.4

(51) Int. Cl. G01N 15/0205; G01N 15/00; G01N 15/02

(52) U.S. Cl. CPC G01N 15/0211; G01N 15/0266; G01N 2015/0003; G01N 2015/0038; G01N 2015/0294

(57) ABSTRACT

The present disclosure relates to the field of photoelectric detection technology, and specifically relates to a micro-nano particle characterization system and characterization method based on AC photovoltaic effect. The present disclosure solves two major technical problems in the sensitivity and measurement accuracy of the existing photoelectric detection technology by innovatively introducing the AC photovoltaic effect. It significantly improves the sensitivity of the photoelectric detector, breaks through the sensitivity bottleneck of traditional technology; it effectively reduces the interference of continuous laser irradiation on micro-nano particles, and improves the measurement accuracy. These technical breakthroughs not only broaden the application scope of photoelectric detection technology, but also provide more accurate and reliable technical means for the characterization of micro-nano particles, which has important scientific significance and application value.

### TECHNICAL FIELD

The present disclosure relates to the field of photoelectric detection, and in particular relates to a micro-nano particle characterization system and characterization method based on alternating current photovoltaic effect.

### BACKGROUND

The photoelectric effect is the basic process of interaction between photons and matter, and it has a wide range of applications in energy, communication, materials science, physics, and other fields. The research on photodetectors/photoelectric detectors has promoted the development of optoelectronics and has had a profound impact on astronomy, optical computing, quantum communication, biomedicine, and other fields. Meanwhile, the photoelectric effect is applied to the characterization of matter to study the electronic structure, physical properties, and chemical composition of materials, which has a wide range of applications in materials science, biological science, medicine, environmental science, and other fields.

Among them, photoelectric detection technology plays a core role in the characterization of micro-nano particles, especially in light scattering technology. When a monochromatic light beam is irradiated to micro-nano particles, scattering occurs. By measuring the energy and distribution of scattered light, the relevant physical properties of the particles are obtained based on Rayleigh scattering theory, Mie scattering theory and Fraunhofer approximation theory. The performance of the photodetector directly determines the accuracy and range of the above measurements. Most traditional photodetection technologies rely on the photovoltaic effect. Its working principle is to expand the depletion region by applying an external voltage, thereby enhancing the light response. However, the photodetectors in the prior art have the problem of insufficient sensitivity, which is mainly manifested in large dark currents and difficulty in detecting extremely weak light signals, resulting in a limited measurement range. Although some technologies have tried to work under zero bias to reduce dark current, due to the low efficiency of carrier separation, the photocurrent output is still greatly limited, and the sensitivity bottleneck has not been broken through, and the needs of high-precision micro-nano particle characterization cannot be met.

In addition, in traditional photoelectric detection technology, the measurement of physical properties of micro-nano particles usually relies on continuous laser irradiation. However, continuous laser irradiation will cause a series of problems, including increased temperature around the particles, changes in the physical properties of the particles, etc. These factors will significantly affect the accuracy of the measurement results. Specifically, continuous laser irradiation will cause the following problems:

Thermal radiation effect: The thermal radiation effect of a continuous light field will cause the temperature around the particles to rise, thereby changing the particle's motion state and affecting the particle's physical properties. Studies have found that continuous illumination can cause thermal expansion or chemical reaction changes in particles, which can cause changes in particle morphology and size, thereby introducing measurement errors. In ultra-high sensitivity physical property characterization, the interference of continuous light fields on particle physical property characterization cannot be ignored.

Excited state interference: When light hits the surface of a particle, the energy of the photon is converted into electronic excitation, which may cause the rearrangement or release of electrons on the particle surface, changing the chemical composition and surface morphology of the particle, thereby affecting the physical properties of the particle. In addition, under the surface plasmon resonance effect, the local electric and magnetic fields generated by the laser on the particle surface will further lead to a local heating effect, which will disrupt the diffusion behavior of the particle and affect the measurement results of its physical properties.

Therefore, the existing photoelectric detection technology has the problem of further improvement in sensitivity and measurement accuracy in the characterization of micro-nanoparticles.

### SUMMARY

In order to solve the above technical problems, the present invention provides a micro-nano particle characterization system and characterization method based on AC photovoltaic effect, which solves the problems of insufficient sensitivity of existing photoelectric detection technology and interference caused by continuous light fields, and improves the accuracy and sensitivity of the characterization of micro-nano particle properties.

The present invention is specifically implemented through the following technical solutions.

The present invention provides a micro-nano particle characterization system based on AC photovoltaic effect, comprising:

A flashing light source module, used to generate an intermittent light signal, wherein the generated intermittent light signal is emitted into a solution of particles to be characterized to generate scattered light.

A photoelectric detection module, including a photoelectric detector for receiving scattered light and generating an AC photoelectric signal; wherein the photoelectric detector includes a semiconductor substrate and an ultra-thin material located on the surface of the semiconductor substrate, wherein the ultra-thin material is an oxide semiconductor, a nitride semiconductor or an organic material semiconductor, and the thickness of the ultra-thin material is 1 Å-500 nm.

A signal processing module, used to analyze the AC photoelectric signal and output the physical parameters of the micro-nano particles.

Herein, the AC photovoltaic effect means that when light is periodically irradiated on the nanoscale junction interface of the material without external bias (0 V) or with a small bias (<1 V), the excess carriers induced by photons are immediately generated and quenched in a non-equilibrium state, and the electrons oscillate back and forth between the two electrodes, generating a large alternating photocurrent in the nanoscale junction. At high switching frequencies, the peak photocurrent of the AC is much higher than the DC current (about 2051 times). This AC signal does not follow Ohm's law, but conforms to the Maxwell displacement current model.

Based on the above-mentioned AC photovoltaic effect, the present invention breaks through the sensitivity bottleneck of traditional photoelectric detection technology: traditional photoelectric detection technology has the limitation of insufficient sensitivity in the detection of weak light signals. By introducing the AC photovoltaic effect, the present invention can obtain a high AC signal under zero bias, avoiding the influence of dark current, so that the detection system of the present invention can provide ultra-high sensitivity to extremely weak light signals, significantly improve the detection accuracy, especially in the detection of scattered light energy of low-concentration micro-nanoparticles, it can achieve higher detection limits and accuracy. According to preliminary experimental results, detectors based on the AC photovoltaic effect have shown record-breaking sensitivity (6.09×10⁹ %), and have exceeded traditional photoelectric detectors by two orders of magnitude in detection ratio (5.4×10¹⁴ Jones). This enables the AC photovoltaic effect to be applied to the detection of scattered signals of ultra-low-concentration micro-nano particles, meeting the needs of high-precision and high-sensitivity physical property characterization.

The present invention effectively suppresses the negative impact of continuous light fields: Studies have shown that laser irradiation can have a negative impact on the measurement of the physical properties of micro-nano particles, which is mainly reflected in the continuous light field causing the particles to deviate from the normal state, resulting in measurement errors. Unlike traditional continuous illumination, the present invention uses a flash field to irradiate micro-nano particles, making full use of the characteristics of the AC photovoltaic effect, and it can effectively reduces the thermal radiation, light absorption and excited state changes of particles caused by continuous laser irradiation. Through the use of the flash field, micro-nano particles can maintain motion in a more stable state that is close to the normal state, thereby ensuring the accuracy of the results of the characterization of the physical properties of the particles and reducing the interference caused by the continuous light field.

Optimize detection materials and structural design: The detector used in the present invention has a nanoscale structure and makes full use of the behavioral effect of excess carriers in the non-equilibrium state in the above-mentioned AC photovoltaic effect, thereby improving the enhancement effect of the AC photovoltaic effect. Through this design, the detector can work normally at a low voltage (0V) and has self-powered characteristics. This not only greatly reduces the generation of dark current, but also provides strong signal output, significantly improving the sensitivity of the detector. At the same time, the optimization of the device structure also helps to improve the detection efficiency of the AC photovoltaic effect, providing a higher performance detection platform for the characterization of the physical properties of micro-nano particles.

Provide a new physical property characterization technology: This invention provides a new technical means for the characterization of the physical properties of micro-nano particles by deeply studying and verifying the basic physical process and principle of the AC photovoltaic effect. Compared with traditional detection methods, the AC photovoltaic effect can break through the limitations of traditional technologies and achieve higher sensitivity and accuracy in physical property detection, which is particularly suitable for the characterization of various physical properties of micro-nano particles in complex physical environments. Combined with dynamic light scattering (DLS) and multi-angle light scattering (MALS) technology, the present invention can accurately measure the diffusion coefficient, particle size distribution, molecular weight, gyration radius, Second Virial Coefficient, concentration, Zeta potential and other physical parameters of micro-nano particles, providing a more accurate and comprehensive analysis tool for the study of the physical properties of micro-nano particles.

Preferably, the intermittent light signal is a pulsed laser with different waveforms.

Preferably, the flashing light source module includes a signal generator, a laser driver and a laser, the signal generator is used to output electrical signals of different waveforms, the laser driver is used to receive the electrical signals and control the laser to output a pulsed laser of target waveform, frequency and intensity.

Preferably, an attenuation module is further provided between the laser and the solution of particles to be characterized, for attenuating the pulsed laser output by the laser.

Preferably, the ultra-thin functional material can be in the form of nanowire arrays (thickness can reach 10 μm), 2D materials (thickness<10 nm), or thin films (inorganic nonmetallic materials <500 nm, organic materials <2 μm thick). The ultra-thin functional material includes but not limited to: tin dioxide, titanium dioxide, zinc oxide, indium tin oxide, aluminum oxide, hafnium oxide, zinc sulfide, zinc selenide, molybdenum disulfide, tungsten disulfide, black phosphorus, graphene, hexagonal boron nitride and various transition metal sulfides; perovskite photoelectric materials include methylammonium lead iodide perovskite, methylammonium lead bromide perovskite, methylammonium lead chloride perovskite, methylammonium lead halide mixed perovskite (such as iodide-bromine, iodide-chloride mixed halide), cesium lead halide perovskite (such as cesium lead Bromide, cesium lead iodide bromine, cesium lead chloride perovskite), lead-tin mixed halide perovskite and bismuth-silver double halide double perovskite; organic semiconductor materials include poly (3-hexylthiophene), poly (3,4-ethylenedioxythiophene) and its sulfonate derivatives, pentaphenylene, anthracene, dibenzoanthracene, fullerene, nickel phthalocyanine, small molecule phthalocyanine, polybenzothiophene, polyfluorene and its copolymers and other small molecule organic dyes; nickel oxide, various copper oxides, gallium nitride, aluminum nitride and MXenes.

The semiconductor substrate includes, but is not limited to: silicon, gallium arsenide, silicon carbide, indium phosphide, gallium nitride, aluminum nitride, germanium, gallium oxide, zinc oxide, cadmium telluride, silicon germanium alloy, silicon on insulating silicon oxide layer, and flexible organic substrate, such as polyimide film, polyethylene terephthalate film, polycarbonate film, polydimethylsiloxane film and polyvinylidene fluoride film, etc. Preferably, the ultra-thin functional material is selected from oxide materials with high stability, such as wide bandgap oxides such as tin dioxide, titanium dioxide, aluminum oxide, zirconium oxide, magnesium oxide, and hafnium oxide; or silicon semiconductor materials such as silicon nitride and aluminum nitride; two-dimensional carbon-based materials such as graphene and transition metal sulfides (MoS₂, WS₂) with excellent stability can also be selected.

Preferably, metal, non-metal or rare earth doping elements are introduced into the ultra-thin material to adjust electrical and optical properties such as carrier concentration, mobility, optical absorption and band gap width; the doping elements include but are not limited to: aluminum-doped zinc oxide, gallium-doped zinc oxide and indium-doped zinc oxide are generated by doping with metal elements such as aluminum, gallium and indium; fluorine-doped tin dioxide, nitrogen-doped titanium dioxide, sulfur-doped titanium dioxide and phosphorus-doped titanium dioxide are generated by doping with non-metal elements such as fluorine, nitrogen, sulfur and phosphorus; tin dioxide, titanium dioxide and other transition metal oxides are further doped with transition metal elements such as titanium, vanadium, chromium, manganese, iron, cobalt, nickel, copper and zinc; rare earth-doped transition metal sulfides are prepared by doping with rare earth elements such as neodymium, terbium and cerium; in addition, boron can be introduced into graphene, iron can be introduced into MXene, and cobalt or nickel can be introduced into transition metal oxides such as manganese oxide and iron oxide; the doping can be done by single doping, co-doping or gradient doping, and the doping concentration is preferably 0.001 at % to 20 at %.

Directly prepare thin films, nanowires, arrays or nanorods on semiconductor substrates. The methods used include but are not limited to a solution method (such as hydrothermal method, hydrothermal assisted sol-gel method, sol-gel method, chemical bath deposition (CBD), dipping method, spin coating method), self-assembly method (such as Langmuir-Blodgett film method, molecular self-assembly SAM, layer-by-layer self-assembly LbL, colloidal crystal self-assembly, electric field induced assembly, evaporation induced assembly and block copolymer template self-assembly), electrochemical method (such as electrochemical deposition/electroplating), vapor deposition method (such as chemical vapor deposition CVD and its metal organic MOCVD, low pressure LPCVD, plasma enhanced PECVD, atomic layer deposition ALD, molecular beam epitaxy MBE), physical vapor deposition PVD (such as thermal evaporation, electron beam evaporation E-beam, magnetron sputtering direct current, radio frequency and reactive modes, ion beam assisted deposition IBAD, multi-arc ion plating, pulsed laser deposition PLD, electron cyclotron resonance deposition ECR and molecular beam physical deposition MBPVD), template-assisted method (hard template, soft template, nanoimprint NIL), gas-liquid-solid growth method (VLS), chemical corrosion (wet etching, dry etching, reactive ion etching, plasma etching), printing and coating technology (inkjet printing, screen printing, microcontact printing, drop coating, spray coating) and electrospinning and other processes; the nanostructure and film preparation method can be used at the same time, that is, one or more of the methods are used to prepare a composite nanostructure, and the method for directly preparing thin films, nanowires, arrays or nanorods on a semiconductor substrate is preferably a hydrothermal method, a vapor deposition method (ALD, MBE, PVD, CVD, etc.).

Preferably, the photoelectric detection module also includes a low-noise pre-current amplifier or a trans-impedance amplifier and an oscilloscope, which are connected to the photoelectric detector to extract the current signal generated by the scattered light and transmit it to the signal processing module for analysis.

The present invention also provides a method for characterizing micro-nano particles based on AC photovoltaic effect (i.e., a micro-nano particle characterization method based on AC photovoltaic effect), which uses the above-mentioned photoelectric detector device for characterization, and it includes the following steps:
in an optical dark box, an intermittent light signal generated by a flashing light source module is emitted into a solution of particles to be characterized to generate scattered light;
the photoelectric detection module is used to receive scattered light and generate an AC photoelectric signal, and the signal processing module is used to analyze the AC photoelectric signal and output the physical parameters of the micro-nano particles.

Preferably, the analysis method includes: the intensity change of the light scattered by the particle will cause the response current of the photoelectric detector to change accordingly, and the response current measured at different angles is substituted into the characteristic curve of the relationship between the response current of the photoelectric detector and the light intensity, so as to obtain the absolute value of the intensity of the light scattered by the particle at different angles and its fluctuation over time; based on the absolute value of the scattered light intensity and its fluctuation over time, the physical parameters of the micro-nano particles are obtained, the physical parameters include the diffusion coefficient, average particle size and particle size distribution, concentration, particle zeta potential, molecular weight, Second Virial Coefficient, gyration radius, and particle shape.

Compared with the prior art, the present invention has the following effects:

This invention applies the AC photovoltaic response effect to the characterization of micro-nano particles for the first time. By utilizing the unique advantages of the AC photovoltaic effect, it solves the problem of insufficient sensitivity of existing photoelectric detection technology and interference caused by continuous light fields, so as to improve the accuracy and sensitivity of the characterization of micro-nano particle properties. Specifically, it includes:

A flashing light source module is used to generate an intermittent light signal, and the generated intermittent light signal is emitted into a solution of particles to be characterized to generate scattered light; a photoelectric detection module includes a photoelectric detector, which is used to receive scattered light and generate an AC photoelectric signal; the photoelectric detector includes a semiconductor substrate and an ultra-thin material located on the surface of the semiconductor substrate, wherein the ultra-thin material is an oxide semiconductor, a nitride semiconductor, a perovskite semiconductor or an organic material semiconductor, and the thickness of the ultra-thin material is 1 Å-500 nm; a signal processing module is used to analyze the AC photoelectric signal and output the physical parameters of the micro-nanoparticles.

Through the above device, in the state of no external bias (0 V) or low bias (□0.8 V), under periodic illumination, photons induce the generation of non-equilibrium excess carriers that oscillate back and forth between the two electrodes, generating extremely high AC current signals, which significantly improves the sensitivity of the photoelectric detector. Experimental results show that compared with traditional photodetection technology, the sensitivity of the present invention is improved by two orders of magnitude, and it can achieve ultra-high sensitivity characterization of micro-nanoparticle properties under extremely weak light conditions. This breakthrough not only broadens the application scope of photodetection technology, but also significantly improves the limit of concentration detection, providing a more accurate technical means for the characterization of micro-nanoparticles.

Different from traditional continuous laser irradiation, the present invention adopts intermittent illumination mode, which significantly reduces the thermal radiation effect and excited state interference of continuous illumination on micro-nano particles. Experiments have shown that this method can provide more accurate micro-nano particle property characterization results, significantly reduce measurement errors, and provide reliable technical support for high-precision micro-nano particle characterization.

The present invention solves two major technical problems in the sensitivity and measurement accuracy of existing photoelectric detection technology by innovatively introducing the AC photovoltaic effect: significantly improving the sensitivity of the photoelectric detector, breaking through the sensitivity bottleneck of traditional technology; effectively reducing the interference of continuous laser irradiation on micro-nano particles, and improving measurement accuracy. These technical breakthroughs not only broaden the application scope of photoelectric detection technology, but also provide more accurate and reliable technical means for the characterization of micro-nano particles, which has important scientific significance and application value.

### BRIEF DESCRIPTION OF THE DRAWINGS

FIG. 1 is a schematic diagram of the structure of the micro-nano particle characterization system based on AC photovoltaic effect.

FIG. 2 shows the relationship between the light scattering technology and the characterization parameters involved in the present invention.

FIG. 3 is a schematic diagram of the improvement idea of the micro-nano particle characterization system based on AC photovoltaic effect of the present invention.

FIG. 4 is a graph showing the change in device response current with the concentration of anatase TiO₂ particle dispersion having an average particle size of 100 nm.

FIG. 5 is a graph showing the relationship between the response current and particles of different average sizes.

### DETAILED DESCRIPTION OF EMBODIMENTS

In order to enable those skilled in the art to better understand the technical solution of the present invention and implement it, the present invention is further described below in conjunction with specific embodiments and drawings, but the embodiments are not intended to limit the present invention. The experimental methods and detection methods described in the following embodiments are conventional methods unless otherwise specified; the reagents and materials described are all commercially available unless otherwise specified.

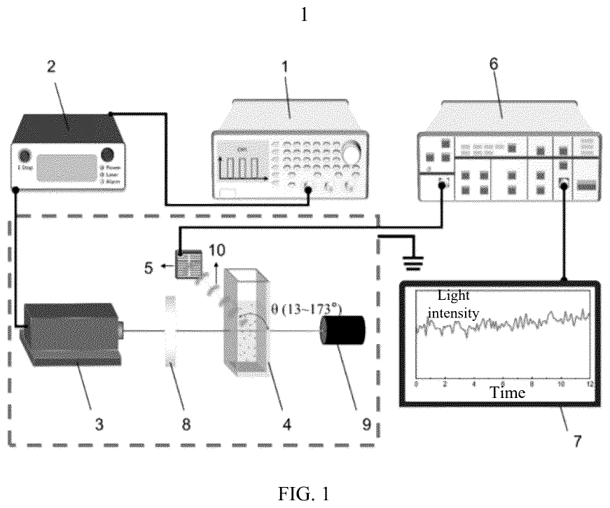

The present invention provides a micro-nano particle characterization system based on AC photovoltaic effect, as shown in FIG. 1, comprising:

A flashing light source module, used to generate an intermittent light signal, wherein the generated intermittent light signal is emitted into a solution 4 of the particles to be characterized to generate scattered light 10. The angle is 13°-173°, preferably 90°.

A photoelectric detection module, used to receive the scattered light 10 and generate an AC photoelectric signal.

A signal processing module 7, used to analyze the AC photoelectric signal and output the physical parameters of the micro-nano particles. The signal processing module 7 is a computer.

Preferably, the intermittent optical signal is a pulsed laser of different waveforms, which may be a sine wave, a square wave or a triangle wave.

The flashing light source module includes a signal generator 1, a laser driver 2 and a laser 3. The signal generator 1 is used to output electrical signals of different waveforms, and the laser driver 2 is used to receive the electrical signals and control the laser 3 to output pulsed lasers of target waveform, frequency and intensity. The laser driver 2 plays a bridging role, converting the electrical signal of the signal generator 1 into a current signal to drive the laser, ensuring that the laser outputs the corresponding optical/light signal according to the target waveform. Among them, the frequency range is 0.01 Hz-100 GHz, and the intensity range is 1 pW-50 W.

Preferably, an attenuation module 8, specifically a neutral density attenuation sheet, is provided between the laser 3 and the solution 4 of the particles to be characterized, for attenuating the pulsed laser output by the laser. A beam terminator 9 is also provided on the other side of the solution 4 of the particles to be characterized away from the attenuation module 8.

Preferably, the photoelectric detection module comprises a photoelectric detector 5, and the photoelectric detector 5 comprises a semiconductor substrate and an ultra-thin material located on the surface of the semiconductor substrate, wherein the ultra-thin material is an oxide semiconductor, a nitride semiconductor or an organic material semiconductor.

Preferably, the ultra-thin functional material can be in the form of nanowire arrays (thickness can reach 10 μm), 2D materials (thickness <10 nm), or thin films (inorganic nonmetallic materials <500 nm, organic materials <2 μm thick), it includes but not limited to: tin dioxide, titanium dioxide, zinc oxide, indium tin oxide, aluminum oxide, hafnium oxide, zinc sulfide, zinc selenide, molybdenum disulfide, tungsten disulfide, black phosphorus, graphene, hexagonal boron nitride and various transition metal sulfides; perovskite photoelectric materials include methylammonium lead iodide perovskite, methylammonium lead bromide perovskite, methylammonium lead chloride perovskite, methylammonium lead halide mixed perovskite (such as iodide-bromine, iodide-chloride mixed halide), cesium lead halide perovskite (such as cesium lead Bromide, cesium lead iodide bromine, cesium lead chloride perovskite), lead-tin mixed halide perovskite and bismuth-silver double halide double perovskite; organic semiconductor materials include poly (3-hexylthiophene), poly (3,4-ethylenedioxythiophene) and its sulfonate derivatives, pentaphenylene, anthracene, dibenzoanthracene, fullerene, nickel phthalocyanine, small molecule phthalocyanine, polybenzothiophene, polyfluorene and its copolymers and other small molecule organic dyes; nickel oxide, various copper oxides, gallium nitride, aluminum nitride and MXenes. The semiconductor substrate includes but is not limited to: silicon, gallium arsenide, silicon carbide, indium phosphide, gallium nitride, aluminum nitride, germanium, gallium oxide, zinc oxide, cadmium telluride, silicon germanium alloy, silicon on insulating silicon oxide layer, and flexible organic substrates, such as polyimide film, polyethylene terephthalate film, polycarbonate film, polydimethylsiloxane film and polyvinylidene fluoride film.

Preferably, metal, non-metal or rare earth doping elements are introduced into the ultra-thin functional material to adjust electrical and optical properties such as carrier concentration, mobility, optical absorption and band gap width; the doping elements include but are not limited to: aluminum-doped zinc oxide, gallium-doped zinc oxide and indium-doped zinc oxide generated by doping with metal elements such as aluminum, gallium and indium; fluorine-doped tin dioxide, nitrogen-doped titanium dioxide, sulfur-doped titanium dioxide and phosphorus-doped titanium dioxide generated by doping with non-metal elements such as fluorine, nitrogen, sulfur and phosphorus; tin dioxide, titanium dioxide and other transition metal oxides further doped with transition metal elements such as titanium, vanadium, chromium, manganese, iron, cobalt, nickel, copper and zinc; rare earth-doped transition metal sulfides prepared by doping with rare earth elements such as neodymium, terbium and cerium; in addition, boron can be introduced into graphene, iron can be introduced into MXene, and cobalt or nickel can be introduced into transition metal oxides such as manganese oxide and iron oxide; the doping can be done by single doping, co-doping or gradient doping, and the doping concentration is preferably 0.001 at % to 20 at %.

Directly prepare thin films, nanowires, arrays or nanorods on semiconductor substrates, using methods including but not limited to solution methods (such as hydrothermal method, hydrothermal assisted sol-gel method, sol-gel method, chemical bath deposition (CBD), dipping method, spin coating method), self-assembly method (such as Langmuir-Blodgett film method, molecular self-assembly SAM, layer-by-layer self-assembly LbL, colloidal crystal self-assembly, electric field induced assembly, evaporation induced assembly and block copolymer template self-assembly), electrochemical method (such as electrochemical deposition/electroplating), vapor deposition method (such as chemical vapor deposition CVD and its metal organic MOCVD, low pressure LPCVD, plasma enhanced PECVD, atomic layer deposition ALD, molecular beam epitaxy MBE), physical vapor deposition PVD (such as thermal evaporation, electron beam evaporation E-beam, DC, RF and reactive modes of magnetron sputtering, ion beam assisted deposition IBAD, multi-arc ion plating, pulsed laser deposition PLD, electron cyclotron resonance deposition ECR and molecular beam physical deposition MBPVD), template-assisted method (hard template, soft template, nanoimprint NIL), gas-liquid-solid growth method (VLS), chemical corrosion (wet etching, dry etching, reactive ion etching, plasma etching), printing and coating technology (inkjet printing, screen printing, microcontact printing, drop coating, spray coating) and electrospinning and other processes.

Preferably, the photoelectric detector 5 is connected to a low-noise pre-current amplifier or a trans-impedance amplifier and an oscilloscope 6 for extracting the current signal generated by the scattered light and transmitting the signal to a signal processing module 7 for processing and analysis.

The present invention also provides a method for characterizing micro-nano particles based on the AC photovoltaic effect, which uses the above-mentioned photoelectric detector device for characterization, and includes the following steps:

In an optical dark box (the portion indicated by the dotted line in FIG. 1), an intermittent light signal generated by a flashing light source module is emitted into a solution of particles to be characterized to generate scattered light.

The photoelectric detection module is used to receive scattered light and generate an AC photoelectric signal, and the signal processing module is used to analyze the AC photoelectric signal and output the physical parameters of the micro-nano particles.

Preferably, the analysis method includes: analyzing the relationship characteristic curve between the AC photovoltaic effect current and the incident light intensity, obtaining the absolute value of the particle scattered light intensity and its fluctuation over time, thereby providing data support for further calculating the physical properties of the particles. Combining the principles of dynamic light scattering (DLS), static light scattering (SLS) and multi-angle light scattering (MALS), the diffusion coefficient, average particle size, particle size distribution and concentration of the particles can be calculated in detail. At the same time, referring to the principle of electrophoretic light scattering (ELS), the present invention can also add electrode plates on both sides of the cuvette, so as to calculate the zeta potential of the particles using electrophoretic light scattering technology. The core advantage of this technology is that the ultra-high sensitivity of the light response of the AC photovoltaic effect can realize the precise detection of the interaction between micro-nano particles and the flash pulse laser, thereby establishing an accurate relationship between the detection signal and the particle-related physical properties. This method not only has extremely high sensitivity, but also can achieve high-precision physical property characterization in low-concentration particle samples, and is particularly suitable for complex physical environments and the synchronous detection of multiple physical parameters.

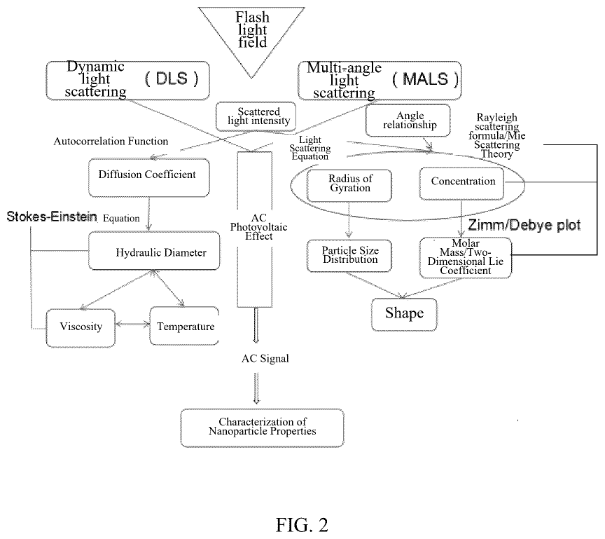

The physical parameters that can be characterized by the present invention include the diffusion coefficient, average particle size and particle size distribution, concentration, zeta potential, molecular weight, two-dimensional coefficient of gyration, radius of gyration, particle shape, etc. of the particles. By changing the experimental conditions and adjusting the parameters of the detector, various physical property data of the particles can be obtained, which makes the present invention have a wide range of applications and can provide a multi-parameter, all-round physical property characterization tool for the study of micro-nano particles. FIG. 2 further illustrates the light scattering technology involved in the present invention and the relationship between it and physical parameters. Through the quantitative relationship between the scattered light intensity of micro-nano particles and various physical properties, the present invention can accurately analyze the behavior of particles in the light field and provide high-precision quantitative analysis of their physical properties. Compared with traditional photoelectric detection technology, although the basic light scattering principle and formula have not changed, the innovation of the present invention is that it uses a combination of flash field and AC photovoltaic effect, which makes the technology show great advantages in sensitivity and anti-interference ability.

The detection system of the present invention can obtain multiple physical parameters of particles such as particle size distribution, shape, concentration, fluid dynamic radius, etc. by adjusting the analysis method of the detection signal. These parameters are not only of great significance to the basic research of micro-nano particles, but can also be widely used in the fields of nanomaterials, nanomedicine, environmental monitoring, etc. Due to the close relationship between the detection signal and the various physical properties of micro-nano particles, the present invention can not only provide high-precision characterization of the physical properties of micro-nano particles, but also adapt to the needs of different particle systems and different experimental environments, and has great practical potential and promotion value.

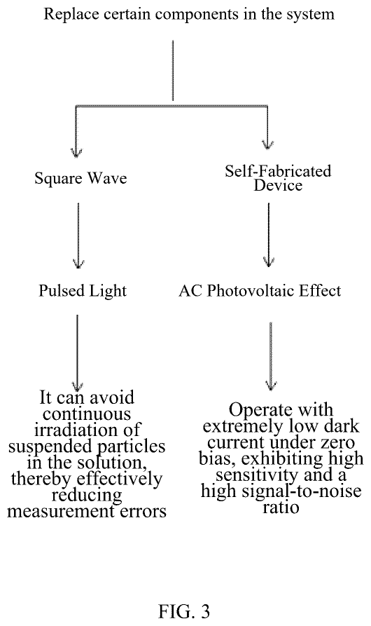

It should be noted that, as shown in FIG. 3, the present invention uses a flash pulse laser and a photoelectric detector based on the AC photovoltaic effect to characterize the physical properties of micro-nano particles. The core testing principle is to combine the scattering of flash laser on micro-nano particles with the characteristics of the AC photovoltaic effect, and to infer the physical parameters of the particles by detecting the relationship between the scattered light intensity and the current fluctuation. Through this principle, the present invention can achieve high-precision, multi-parameter characterization of micro-nano particles. The key points are:

Application of new physical effects: For the first time, the AC photovoltaic effect is applied to the characterization of micro-nanoparticles, and ultra-high sensitivity detection is achieved by using the AC photoelectric signal generated at the moment of light turning on and off.

It should be noted that the AC photovoltaic effect is:

In the state of no external bias (0 V), when light is periodically irradiated on the nanoscale junction interface of the material, the excess carriers induced by photons are immediately generated and quenched in a non-equilibrium state, and the electrons oscillate back and forth between the two electrodes, generating a large alternating photocurrent in the nanoscale junction. At high switching frequencies, the peak photocurrent of the AC is much higher than the DC current (about 2051 times). This AC signal does not follow Ohm's law, but conforms to the Maxwell displacement current model. Under periodic illumination, photons induce the generation of non-equilibrium excess carriers that oscillate back and forth between the two electrodes, generating extremely high AC current signals. The reason for this phenomenon is that under non-equilibrium conditions, the excess carriers generated by the semiconductor cause a relative shift between the quasi-Fermi energy levels at the material interface, resulting in an imbalance in the charge distribution, and electrons flow in the external circuit to establish a new equilibrium to balance the potential difference between the electrodes.

Material innovation: The ultra-thin functional material can be in the form of nanowire arrays (thickness can reach 10 μm), 2D materials (thickness <10 nm), or thin films (inorganic nonmetallic materials <500 nm, organic materials <2 μm thick). Titanium dioxide (TiO₂) and tin dioxide (SnO₂) are currently preferred, and other oxides, nitrides, perovskites and organic materials can be used. The nanoscale junction structure, this material design can significantly enhance the performance of the AC photovoltaic effect. Nanoscale structural materials can provide a higher surface area and more non-equilibrium carriers, thereby promoting the generation of the AC photovoltaic effect. This choice of material structure makes the device more responsive when detecting weak signals and can effectively characterize the physical properties of extremely small particles.

Light source design: Use flash light as the light source to generate AC photoelectric signals at the moment when the light is turned on and off, avoiding the thermal radiation effect and excited state interference caused by continuous laser irradiation.

Self-powered characteristics: no external voltage or weak voltage (<0.8V) is required

The scattered light is detected by using the AC photovoltaic effect through the scattering of scintillation light by micro-nanoparticles.

The present invention, by adopting AC photovoltaic effect light detection technology, brings significant improvements in all aspects, including:

Improved detection performance: The present invention uses the AC photovoltaic effect as the core detection principle. Compared with traditional photoelectric detection technology, its biggest advantage lies in its ultra-high sensitivity to light. The AC photovoltaic effect can produce a strong response under extremely weak light signals, so that the present invention can be used for high-precision detection of low-concentration target substances. This ultra-high sensitivity light response greatly improves the detection limit, and is particularly suitable for the detection and physical property characterization of low-concentration micro-nanoparticles, effectively improving the shortcomings of traditional technologies in this regard. In addition, due to the use of ultra-thin materials (polycrystalline, single crystal, amorphous) instead of single crystal materials prepared at high temperatures, the preparation cost of the present invention is significantly reduced, and the wide range of materials further reduces the material cost.

Low cost: The photoelectric detector of the present invention uses ultra-thin materials, avoiding the high-temperature preparation process required for traditional single crystal materials, and greatly reducing the preparation cost. Ultra-thin materials are not only inexpensive, but also have a wide range of materials, including but not limited to oxide materials such as titanium dioxide (TiO₂), tin dioxide (SnO₂), nitrides, perovskite materials and organic materials. This low-cost material selection and preparation process gives the present invention a significant economic advantage and is suitable for large-scale production and application.

Low energy consumption: The photoelectric detector of the present invention has a self-powered characteristic and can work without an external bias. Unlike traditional photoelectric detectors that require an external bias, the device of the present invention can operate under 0V conditions. The advantage of this feature is that it can provide a strong signal output without increasing additional energy consumption while maintaining an extremely low dark current. This makes the system easier to operate, can be widely used in different experimental environments, and reduces the complexity and energy consumption of traditional photoelectric detectors during use. In addition, since no external voltage is required to drive it, the energy consumption of the present invention is significantly reduced, further improving its economy and environmental protection in practical applications.

The application of flash field reduces the negative impact of continuous light field: The present invention innovatively uses flash field as the laser irradiation source. Compared with the traditional continuous illumination method, the flash field can effectively reduce the thermal radiation, light absorption and particle state changes caused by the laser on micro-nano particles during operation. Studies have shown that continuous light fields may cause micro-nano particles to deviate from the normal state, thereby affecting the accuracy of physical property measurement. By adopting the flash field, micro-nano particles can maintain a relatively stable state when receiving short-pulse lasers, thereby improving the accuracy of the characterization of particle physical properties. This design not only improves the measurement accuracy, but also reduces the energy consumption caused by continuous illumination, further reducing the overall energy consumption of the system.

Lower concentration detection limit and higher concentration discrimination: Due to the ultra-high sensitivity of the AC photovoltaic effect, the present invention can break through the detection limit of traditional technology and realize the detection of micro-nanoparticles at extremely low concentrations. By improving the resolution of the detector, the present invention can more accurately distinguish target substances of different concentrations and has a higher concentration discrimination. This advantage enables the present invention to provide higher measurement accuracy and signal-to-noise ratio in the measurement of micro-nanoparticles, especially in low concentrations and weak signals. At the same time, due to the use of low-cost materials and low-energy consumption design, the present invention maintains low economic costs and energy consumption while achieving high-precision detection.

Comprehensive advantages and application prospects: The present invention not only improves the sensitivity and accuracy of micro-nano particle characterization by introducing the AC photovoltaic effect, new self-made devices and the application of flash fields, but also significantly improves the various limitations in traditional photoelectric detection technology, providing a new technical means for high-precision, multi-parameter physical property characterization of micro-nano particles. These significant effects make the present invention have broad application prospects in nanotechnology, physical chemistry research and related fields. In addition, the low-cost and low-energy consumption characteristics of the present invention make it have huge market potential in industrial detection, environmental monitoring, biomedicine and other fields, and can meet the needs of large-scale applications.

To further illustrate the present invention, the present invention was tested as follows:

(1) Detection of Low Concentration Micro-Nanoparticles

A photoelectric detector based on the AC photovoltaic effect is used to detect low-concentration micro-nano particles.

Step 1: By adjusting the laser pulse frequency (200 Hz) and intensity (32.4 mW), square wave pulse laser is irradiated at 90° onto the micro-nano particles suspended in the solution (in an optical dark box).

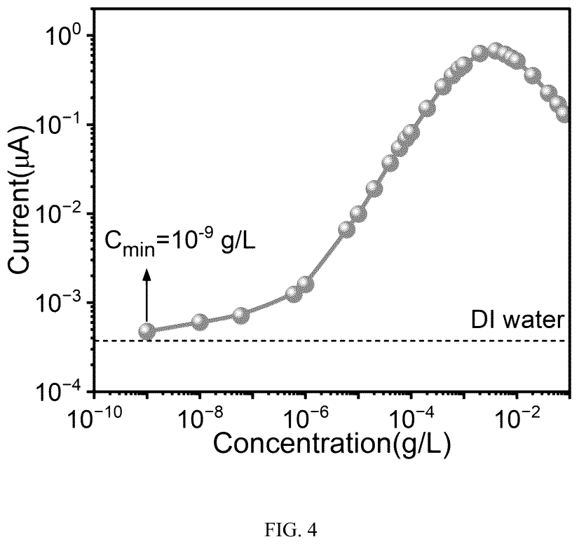

Step 2: receiving scattered light with the aid of a photoelectric detector, obtaining a current value, measuring a scattered light intensity signal, and analyzing the data, the result is shown in FIG. 4. The photoelectric detector includes a P-type silicon substrate, a 15 nm TiO₂ film is deposited on the P-type silicon substrate as an active layer, and then ITO and aluminum electrodes are deposited on the TiO₂ surface and the back of the P-type silicon substrate, respectively. FIG. 4 shows the change in the device response current with the concentration of a dispersion of rutile TiO₂ particles with an average particle size of 100 nm. The results show that the detector of the present invention can successfully extract the scattered signal of particles at such a low concentration, and the detection accuracy is greatly improved. Compared with traditional photoelectric detectors, its sensitivity is greatly improved. This experiment verifies the superiority of the present invention in the detection of low-concentration micro-nano particles, showing ultra-high detection sensitivity and accuracy.

Another important feature of the present invention is the self-powered property of the photoelectric detector, that is, it can work normally without external bias (or applying a very small bias). Compared with traditional photoelectric detectors that require an external power supply to provide a bias, the self-powered property of the present invention does not require an external power supply, avoiding the negative impact of an external power supply increasing the dark current, greatly simplifying the operation process, and improving the adaptability and reliability under complex experimental conditions.

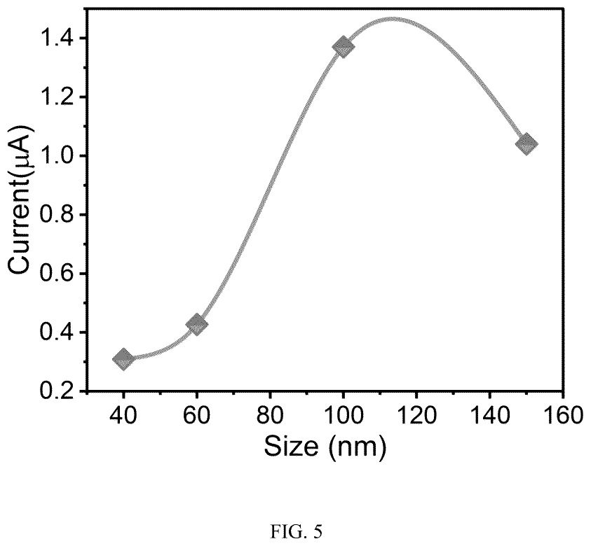

(2) Characterization of particles of different particle sizes: The photoelectric detector in (1) was used to test anatase TiO₂ dispersions of different average particle sizes (all with a concentration of 10⁻³ g/L). A square wave pulse laser (200 Hz, 32.4 mW) was incident vertically at 90° on samples of each particle size, the device response current was recorded, and the corresponding average scattered light intensity was calculated. The experimental results are shown in FIG. 5. The response currents generated by samples of different particle sizes are significantly different. The particle size can be accurately mapped out by the scattered light intensity, and TiO₂ particles of different average particle sizes can be clearly distinguished. This experiment further demonstrates the high sensitivity and high accuracy of the present invention in particle size characterization.

Through the verification of multiple test cases, the micro-nano particle characterization method based on AC photovoltaic effect of the present invention has shown ultra-high sensitivity, accurate detection ability and good adaptability in the detection of particles of different concentrations, sizes, types and crystal forms. These experimental results fully demonstrate the wide application prospects and feasibility of the present invention.

Obviously, those skilled in the art can make various changes and modifications to the present invention without departing from the spirit and scope of the present invention. Thus, if these modifications and variations of the present invention fall within the scope of the claims of the present invention and their equivalents, they are also intended to be included.

What is claimed is:

1. A micro-nano particle characterization system based on AC photovoltaic effect, comprising:
a flashing light source module, configured to generate an intermittent light signal, wherein the generated intermittent light signal is emitted into a solution of particles to be characterized to generate scattered light;
a photoelectric detection module comprising a photoelectric detector for receiving scattered light and generating an AC photoelectric signal, wherein the photoelectric detector includes a semiconductor substrate and an ultra-thin material located on a surface of the semiconductor substrate, wherein the ultra-thin material is an oxide semiconductor, a nitride semiconductor or an organic material semiconductor, and the thickness of the ultra-thin material is 1 Å-500 nm;
a signal processing module, configured to analyze the AC photoelectric signal and output physical parameters of the micro-nano particles.

2. The micro-nano particle characterization system based on AC photovoltaic effect according to claim 1, wherein the intermittent light signal is a pulsed laser with different waveforms.

3. The micro-nano particle characterization system based on AC photovoltaic effect according to claim 2, wherein the flashing light source module includes a signal generator, a laser driver and a laser, the signal generator is used to output electrical signals of different waveforms, and the laser driver is used to receive the electrical signals and control the laser to output a pulsed laser of a target waveform, frequency and intensity.

4. The micro-nano particle characterization system based on AC photovoltaic effect according to claim 3, wherein an attenuation module is further provided between the laser and the solution of particles to be characterized, for attenuating the pulsed laser output by the laser.

5. The micro-nano particle characterization system based on AC photovoltaic effect according to claim 1, wherein the ultra-thin material is tin dioxide, titanium dioxide, zinc oxide, indium tin oxide, aluminum oxide, hafnium oxide, zinc sulfide, zinc selenide, molybdenum disulfide, tungsten disulfide, black phosphorus, graphene, hexagonal boron nitride and various transition metal sulfides; perovskite photoelectric materials include methylammonium lead iodide perovskite, methylammonium lead bromide perovskite, methylammonium lead chloride perovskite, methylammonium lead halide mixed perovskite (such as iodide-bromine, iodide-chloride mixed halide), cesium lead halide perovskite (such as cesium lead Bromide, cesium lead iodide bromine, cesium lead chloride perovskite), lead-tin mixed halide perovskite and bismuth-silver double halide double perovskite; organic semiconductor materials include poly (3-hexylthiophene), poly (3,4-ethylenedioxythiophene) and its sulfonate derivatives, pentaphenylene, anthracene, dibenzoanthracene, fullerene, nickel phthalocyanine, small molecule phthalocyanine, polybenzothiophene, polyfluorene and its copolymers and other small molecule organic dyes; nickel oxide, various copper oxides, gallium nitride, aluminum nitride and MXenes;
wherein the semiconductor substrate is silicon, gallium arsenide, silicon carbide, indium phosphide, gallium nitride, aluminum nitride, germanium, gallium oxide, zinc oxide, cadmium telluride, silicon-germanium alloy, silicon on an insulating silicon oxide layer, polyimide film, polyethylene terephthalate film, polycarbonate film, polydimethylsiloxane film or polyvinylidene fluoride film.

6. The micro-nano particle characterization system based on AC photovoltaic effect according to claim 1, wherein a doping element is introduced into the ultra-thin material to adjust the electrical and optical properties of the material; the doping element is a metal element, a non-metal element or a rare earth element; the doping method adopted is single doping, co-doping or gradient doping, and the doping concentration is 0.001 at % to 20 at %.

7. The micro-nano particle characterization system based on AC photovoltaic effect according to claim 1, wherein a thin film, nanowire, array or nanorod structure is directly prepared on the semiconductor substrate, and the method adopted is a solution method, a self-assembly method, an electrochemical method, a vapor deposition method, a physical vapor deposition PVD, a template-assisted method, a gas-liquid-solid growth method, a chemical corrosion, a printing and coating process or an electrospinning process.

8. The micro-nano particle characterization system based on AC photovoltaic effect according to claim 1, wherein the photoelectric detection module further includes a low-noise pre-current amplifier or a trans-impedance amplifier, and an oscilloscope, and the low-noise pre-current amplifier or the trans-impedance amplifier, and the oscilloscope are connected to the photoelectric detector to extract a current signal generated by the scattered light and transmit it to the signal processing module for analysis.

9. A micro-nano particle characterization method based on AC photovoltaic effect, wherein the characterization method is performed using the micro-nano particle characterization system according to claim 1, and the the characterization method comprises the following steps:
in an optical dark box, an intermittent light signal generated by the flashing light source module is irradiated into a solution of particles to be characterized at different angles to generate scattered light;
the photoelectric detector is used to receive the scattered light and generate an AC photoelectric signal, and the signal processing module is used to analyze the AC photoelectric signal and output the physical parameters of the micro-nano particles.

10. The micro-nano particle characterization method based on AC photovoltaic effect according to claim 9, wherein the analysis method comprises:
a changing response current measured at different angles is substituted into a characteristic curve of the relationship between the response current of the photoelectric detector and the change of light intensity to obtain an absolute value of the particle scattered light intensity at different angles and its fluctuation over time;
based on the absolute value of the scattered light intensity obtained and its fluctuation over time, the physical parameters of the micro-nano particles are obtained, the physical parameters include diffusion coefficient, average particle size and particle size distribution, concentration, particle zeta potential, molecular weight, Second Virial Coefficient, gyration radius and particle shape of the particles.
